(19) United States
(12) Patent Application Publication
(10) Pub. No.: US 2008/0144074 A1
(43) Pub. Date: Jun. 19, 2008

(54) WORKFLOW PROCESSING SYSTEM

(76) Inventor: Jie Lin, Rochester, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/550,504

(22) Filed: Oct. 18, 2006

(51) Int. Cl. G06F 3/12

(52) U.S. Cl. 358/1.15

(57) ABSTRACT

Methods and systems for performing multi-objective optimization for scheduling a plurality of jobs are disclosed. A plurality of jobs, each requiring the performance of one or more operations, may be received. A plurality of feasible routes, each including one or more resources, may be determined for each job. Each resource may be assigned to perform at least one operation for the job. A plurality of objectives may be received and combined to form a multi-objective function. Each objective may be based on at least one of a job, a feasible route and a resource. A sequence in which to perform the plurality of jobs and a feasible route for each job may be determined by substantially minimizing the multi-objective function for the plurality of jobs and the plurality of feasible routes.

### BACKGROUND

1. Technical Field

The present disclosure generally relates to systems and methods for performing multi-objective optimization in a document processing system. More particularly, the present disclosure relates to systems and methods for simultaneously optimizing the assignment of job resources and the sequence in which jobs are performed when generating a workflow and/or document processing schedule.

2. Background

A typical job and/or workflow scheduling problem in document production environments assigns jobs to resources and orders the jobs to achieve an optimization objective,

such as minimizing the total turnaround time, ensuring that no jobs complete later than a defined time and/or the like. In conventional systems, the processes used to assign jobs to resources and order (i.e., sequence) jobs are decoupled. In other words, jobs are first assigned to feasible resources and then ordered according to predefined sequencing rules, such as first-in first-out (FIFO), last-in last-out (LILO), earliest due date (EDD), shortest processing time (SPT) and the like.

One shortcoming of such an approach is that it cannot account for optimization objectives other than total processing time. For example, an objective function, such as the number of late jobs, requires knowledge of each job's starting and stopping times. However, this information can only be available if the job processing sequence is known. In other words, conventional job scheduling systems in document production systems merely generate job resource assignments that optimize a particular objective function and cannot generate a job sequence other than one using a predefined sequencing rule. As a result, conventional job scheduling and/or workflow systems cannot perform multi-objective optimization.

Ant colony optimization (ACO) algorithms are a class of heuristic search algorithms that have been successfully applied to solving NP-hard problems. ACO algorithms are biologically inspired from the behavior of colonies of real ants, and in particular how they forage for food.

The principle behind the ACO algorithm is that ants can communicate with one another through indirect means by making modifications to the concentration of highly volatile chemicals called pheromones in their immediate environment. For example, if a group of ants encounter an obstacle and are required to select between one of two alternate paths, approximately half of the ants will initially select each path. As the ants walk along each path, a pheromone trail is left behind. If one path is shorter than the other, ants approaching from the other end of the paths will detect the pheromone trail laid by ants that traversed the shorter path earlier in time and will follow that path. Accordingly, the ants approaching from the other end can detect that previous ants had selected the shorter path and will select that path because it has a higher pheromone concentration. As more ants tend to walk along the shorter path, the pheromone concentration on the shorter path will increase, while the pheromone concentration on the longer path will tend to decrease over time. This further encourages future ants to walk along the shorter path. Ultimately the pheromone concentration on the shorter path dominates and ants choosing between the two paths will select the shorter path with probability approaching 1.

With respect to the use of ACO algorithms, weighting factors are influenced, for example, by processing sequence selections made in previous iterations. Good processing sequences (i.e., sequences that best satisfy predefined objectives) can be favored over other processing sequences. Alternately or additionally, bad processing sequences (i.e., sequences that do not satisfy the objectives well) can be disfavored. As such, when processing sequences are selected in subsequent iterations, the selection algorithm is more likely to favor processing sequences that performed well (and/or disfavor processing sequences that did not perform well) in previous iterations. The operation and performance of ACO algorithms are described in Marco Dorigo et al., “The Ant System: Optimization by a Colony of Cooperating Ants,” IEEE Transactions on Systems, Man, and Cybernetics, 26:29-41 (February 1996) and Karl Doerner et al., “Ant Colony Optimization in Multiobjective Portfolio Selection,” 4^{th} Metaheuristics International Conference, pp 243-248 (Jul. 16-20, 2001).

Systems and methods for simultaneously optimizing a plurality of objectives for a workflow scheduling and/or job processing system and for assigning an ordered sequence of jobs to available resources such that a plurality of objectives are satisfied would be desirable.

### SUMMARY

Before the present methods are described it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one of ordinary skill in the art. As used herein, the term “comprising” means “including, but not limited to.”

In an embodiment, a method for performing multi-objective optimization for scheduling a plurality of jobs may include receiving a plurality of jobs each requiring the performance of one or more operations, determining a plurality of feasible routes for each job each feasible route including one or more resources that are each able to perform at least one operation for the job, receiving a plurality of objectives each based on at least one of a job, a feasible route and a resource, and determining a sequence in which to perform the plurality of jobs and a feasible route for each job by determining a substantially best-case result for the multi-objective function for the plurality of jobs and the plurality of feasible routes.

In an embodiment, a system for performing multi-objective optimization for scheduling a plurality of jobs may include an input interface, a route determination module and a multi-objective constraint solver. The input interface may receive a plurality of jobs and a plurality of objectives. Each job may require the performance of one or more operations. Each objective may be based on at least one of a job, a feasible route and a resource. The plurality of objectives may be combined to form a multi-objective function. The route determination module may determine a plurality of feasible routes for each job, Each feasible route may include one or more resources. Each resource may be able to perform at least one operation for the job. The multi-objective constraint solver for determining a sequence in which to perform the plurality of jobs and a feasible route for each job by determining a substantially best-case result for the multi-objective function for the plurality of jobs and the plurality of feasible routes.

### BRIEF DESCRIPTION OF THE DRAWINGS

Aspects, features, benefits and advantages of the present invention will be apparent with regard to the following description and accompanying drawings, of which:

FIG. 1 depicts a flow diagram of an exemplary method for performing resource assignment and job processing order for a plurality of jobs.

FIG. 2 depicts a block diagram for an exemplary system for performing multi-objective optimization according to an embodiment.

### DETAILED DESCRIPTION

With respect to a document processing system, a “job” refers to data relating to one or more images and/or documents to be printed or processed and one or more instructions regarding how to process the data. A job includes one or more operations that are performed on each image and for document. Exemplary jobs include, without limitation, assembling a printed periodical or book, putting together a bound presentation, printing and cutting business cards, or the like,

An “operation” is a portion of a job that is performed on a document. Exemplary operations for document processing include, without limitation, printing, cutting, folding, binding, and the like.

A “resource” is a machine that performs an operation. For example, a printing operation can be performed on a resource, such as a printer. Other exemplary resources include, without limitation, scanners, fax machines, cutting machines, binding machines, folding machines and the like. A resource can perform more than one operation for a particular job, such as a machine that folds and cuts paper.

A “multi-objective function” is a friction that is evaluated when performing the algorithm described hereinbelow. The multi-objective function may include a variable for each objective. The variable may denote the effectiveness of a selected job sequence and resource assignment at satisfying each objective. For example, if one objective is to minimize the number of late jobs, the variable for that objective could represent the number of late jobs. Each variable is weighted based on the relative importance of that objective. If all objectives are equally important, each variable may be normalized and have the same weight applied to it. Exemplary objectives are listed below.

An “ant” is a selection process. An ant selects a job that has not previously been selected by the ant in an iteration based on values contained in a sequence probability matrix and a set of resources (a feasible route) to perform the job based on values contained in a route probability matrix. The ant selects each job, and a route for each job, once in each iteration. Once all jobs are selected for a particular iteration, the multi-objective function is evaluated for the job sequence and route assignment. The selections made by multiple ants are evaluated in each iteration.

Multi-objective optimization may be performed using an optimization algorithm that solves for a plurality of objectives simultaneously. Exemplary optimization algorithms may include Ant Colony Optimization algorithms, Simulated Annealing, Genetic Algorithms and the like. While the description contained herein refers to a modified ACO algorithm, one of ordinary skill in the art will recognize that embodiments using any multi-objective optimization algorithm are possible. Such embodiments are intended to be included within the scope of this disclosure.

When performing multi-objective optimization, a plurality of jobs and a plurality of desired objectives may be presented. An iterative algorithm may be performed to simultaneously determine the order of the jobs and the resources to which the jobs are assigned. This determination may be performed to satisfy the desired objectives in an optimized fashion.

In each iteration of the iterative algorithm, a job processing order and a resource assignment may be selected. The job processing order and resource assignment may then be used to calculate the value of a multi-objective function. This value may affect the selection of job processing orders and resource assignments in subsequent iterations. The job processing order and resource assignment determined by the algorithm may eventually converge to a steady state. This steady state may represent an optimized value for the multi-objective function.

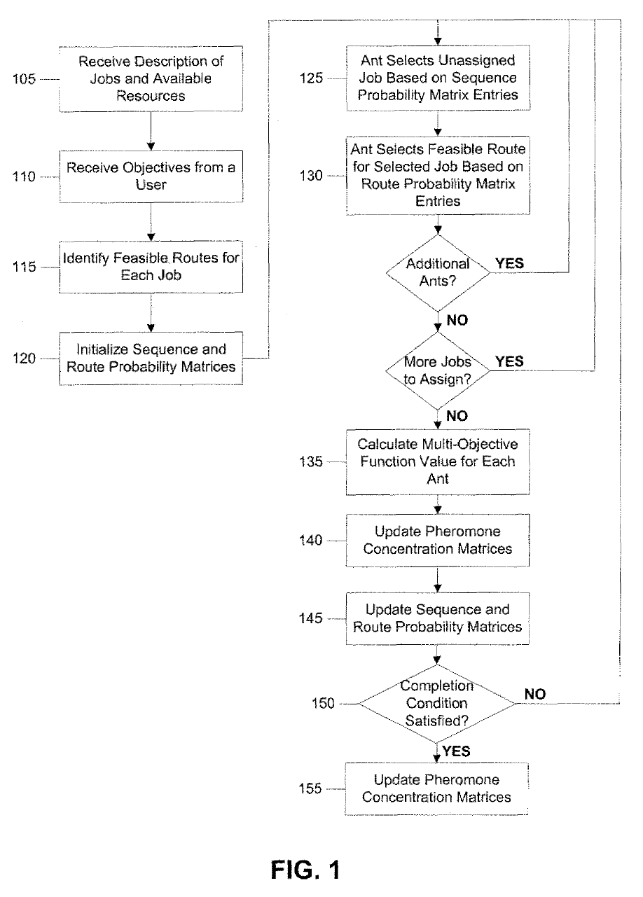

FIG. 1 depicts a flow diagram of an exemplary method for determining resource assignment and job processing order for a plurality of jobs. Referring to FIG. 1, a plurality of jobs and a plurality of resources for performing the jobs may be received 105. For example, n jobs (J₁, J₂, . . . , Jₙ) and D resources (m₁ m₂, . . . , m_{D}) may be considered in an embodiment. In addition, a plurality of objectives may be provided 110 by a user. Exemplary objectives to be satisfied by the algorithm may include, without limitation, minimizing the total turnaround time for performing the set of jobs, minimizing the number of late jobs, minimizing the total amount of lateness for each job, maximizing the utilization of the resources, and/or maximizing the earliness with which each job completes. In the embodiment disclosed hereinbelow, two objectives, minimizing the total turnaround time (T=the total turnaround time) and minimizing the number of late jobs (L=the number of late jobs), are considered. However, it will be apparent to those of ordinary skill in the art that additional and/or alternate objectives may be considered within the scope of the present disclosure.

A multi-objective function such as F=w₁T+w₂L, may be defined based on the selected objectives. w₁ and w₂ may be weights determined by a user, where w₁+W₂−1, w₁>0 and w₂>0. In an embodiment, a job sequence and resource assignment having a minimum value for the multi-objective function may identify a process that best satisfies the selected objectives. In an alternate embodiment, a maximum value may represent the best result.

Each job may include, for example and without limitation, the following information: an arrival date, a due date, one or more operations (o₁ . . . oₖ) to be performed in sequence and the size (s₁ . . . sₖ) of each operation. The size may correspond to the amount of time required to complete the operation. Alternately, the size may correspond to a different metric related to the objectives to be satisfied.

For a colony of m>0 ants (i.e. selection processes), n>0 jobs and D>0 resources, feasible physical routes may be identified 115 for each job. A feasible physical route is a mapping between the operations of a job and the resources that can perform each operation. Feasible physical routes are constrained such that the output of a first resource for a first operation must be able to supply its output to a second resource that performs a subsequent operation. Each feasible physical route may include one or more resources. Each resource may perform one or more operations.

A number of feasible physical routes, rᵢ may be determined for each job, Jᵢ, i=1, 2, . . . . , n. The actual feasible physical routes for each job may be denoted by Rₖⁱ, where k=1, 2, . . . , rᵢ. In other words, each Rₖⁱ may list the resources that job Jᵢ traverses for corresponding feasible route k. In addition, G may be defined as the set of unique feasible physical routes in Rₖⁱ, and the cardinality of G may be defined as R. As such, G may be represented as [G₁, G₂, . . . , G_{R}], where each Gᵢ=1, 2, . . . , R corresponds to one feasible physical route.

A sequence probability matrix V, of size n×n, and a route probability matrix P, of size n×R, may then be initialized 120. Entry Vᵢⱼ may represent the probability of one ant placing job Jᵢ in the j^{th} position of its job processing sequence. In an embodiment, V may be initialized such that each entry Vᵢⱼ is set equal to 1. In other words, each job may have an equal probability of being assigned to any position in a job order sequence during the first iteration. Entry Pᵢⱼ may represent the probability of job Jᵢ being assigned to feasible physical route Gⱼ by an ant. Each job may have a number of feasible physical routes that is less than or equal to R. As such, in an embodiment, only entries corresponding to a feasible physical route for a particular job may be set equal to 1. All other entries may be set equal to 0. In an alternate embodiment, values other than 1 or 0 may be used to initialize sequence probability matrix V and route probability matrix P. In an embodiment, the entries of V and P may be normalized on a job-by-job basis.

At the beginning of each iteration, each ant may select 125 an unassigned job based on sequence probability matrix V and assign 130 it to a feasible physical route according to route probability matrix P. An iteration may complete when each of the m ants have selected and assigned all n jobs. As such, each iteration may include n time steps for each ant. During each iteration, each ant may determine the sequence in which jobs will be processed and the assignment of jobs to feasible physical routes. The processing sequence may result from the job selection process performed at each time step, t=1, 2, . . . , n.

At timer t=1, 2, . . . , n during an iteration, an ant k may select 125 job Jᵢ (i.e., may place job Jᵢ in the b^{th} position in its job processing queue) with a probability provided by the following equation:

$${V}_{ib}^{k} ( t ) = \{ \begin{matrix} \frac{{γ}_{ib} ( t )}{{\sum }_{r ∉ {S}_{1}} {γ}_{rb} ( t )} , & if i ∉ {S}_{1} \\ 0 , & otherwise\end{matrix} ,$$

where γ_{ib}(t) is the value of the entry of a pheromone concentration matrix γ for job Jᵢ and sequence position b at time t; and S₁ is a taboo list that contains the set of already selected jobs.

In an embodiment, the pheromone concentration matrix entries γᵢⱼ(t) may have values between 0 and 1, inclusive, and may be updated 140 at the completion of each iteration based on the following equation: γᵢⱼ(t+n)=γᵢⱼ(t)*(1−ρ)+Δγᵢⱼ^{q}, where ρ is a coefficient such that (1−ρ) represents the evaporation of pheromone between times t and t+n; q is the index of the ant that finds the minimum multi-objective function value F=w₁T+w₂ L; and

$${Δγ}_{ij}^{q} = \{ \begin{matrix} \frac{Q}{{F}_{q}} , & if ant q places job {J}_{i} in the {j}^{rth} place in its queue \\ 0 , & otherwise\end{matrix} ,$$

where Q is a pre-specified positive constant, and F_{q} is the minimum multi-objective function value. Alternate updating functions for the pheromone matrix γ may be used within the scope of this disclosure.

Also at time t=1, 2, . . . , n during an iteration, an ant k may assign 130 job Jᵢ to a feasible physical route Gⱼ with a probability provided by the following equation:

$${P}_{ij}^{k} ( t ) = \{ \begin{matrix} \frac{{{[ {τ}_{ij} ( t ) ]}^{α} [ {η}_{ij} ]}^{β}}{{\sum }_{r ∈ {S}_{2}} {{[ {τ}_{ij} ( t ) ]}^{α} [ {η}_{ij} ]}^{β}} , & if j ∈ {S}_{2} \\ 0 , & otherwise\end{matrix} ,$$

where τᵢⱼ(t) is the value of an entry of a pheromone concentration matrix τ for job Jᵢ and feasible physical route Gⱼ at time t; ηᵢⱼ is the value of a heuristic function matrix η for job Jᵢ and feasible physical route Gⱼ, and S₂ is the set of feasible physical routes for job Jᵢ. The parameters α and β may be used to assign the relative importance for the pheromone concentration value and heuristic value, respectively.

The use of heuristic matrix q may be optional. In an embodiment, a heuristic model may include information pertaining to the completion time of a job on each feasible physical route. In an embodiment, when determining the feasible physical route to select for a particular job, a heuristic may favor the route that has the earliest completion time. Using this heuristic, ηᵢⱼ may be inversely proportional to the completion time and may be provided by the following equation:

$${η}_{ij} = \frac{{min}_{r ∈ {S}_{2}} ( {CT}_{ir} )}{{CT}_{ij}} , j ∈ {S}_{2} ,$$

where CTᵢⱼ is the completion time of job Jᵢ if it is assigned to route Gⱼ. If the heuristic model is not included, β may be set equal to 0.

In an embodiment, the pheromone concentration matrix entries τᵢⱼ(t) may be between 0 and 1, inclusive, and may be updated 140 at the completion of each iteration based on the following equation: τᵢⱼ(t+n)=τᵢⱼ(t)*(1−ρ)+Δτᵢⱼ^{q}, where ρ is a coefficient such that (1−ρ) represents the evaporation of pheromone between time t and t+n; q is the index of the ant that finds the minimum multi-objective function value F=w₁T+w₂L; and Δτᵢⱼ^{q} is the quantity per unit of length of trail substance (pheromone in real ants) laid on edge (i, j) by the q^{th} ant (e.g., the best ant) between time t and t+n. The quantity per unit length may be determined by the following equation:

$${Δτ}_{ij}^{q} = \{ \begin{matrix} \frac{Q}{{F}_{q}} , & if ant q assign s job {J}_{i} to route {G}_{j} ( between time t and t + n ) \\ 0 , & otherwise\end{matrix} ,$$

where Q is a pre-specified positive constant, and F_{q} is the minimum multi-objective function value. Alternate updating functions for the pheromone matrix r may be used within the scope of this disclosure.

When all n time steps for an iteration have been completed, the value of the multi-object function may be calculated 135 for each ant. The best ant, q, may be, for example, the ant that has the minimum value for the multi-objective function, F_{q}. The value F_{q} may then be used to update 140 the pheromone concentration matrices γ and τ, which, in turn, update 145 the sequence probability matrix V and the route probability matrix P. In an embodiment, sequence probability matrix V may be the same as pheromone concentration matrix γ and route probability matrix P may be the same as pheromone concentration matrix τ.

In an embodiment, a different ant or a plurality of ants may be selected to update 140 the pheromone concentration matrices. For example, the ant having the maximum value for the multi-objective function may be selected to reduce the chance that the sequence is selected in the future. In an alternate embodiment, an ant having a median value for the multi-objective function may be selected. Alternately, a plurality of ants or all ants may be selected to update the pheromone concentration matrices. In such an embodiment, the effect that each ant has on the pheromone concentration matrices may depend upon the relative value of the multi-objective function for such ant.

Once the sequence probability matrix V and the route probability matrix P have been updated 145, a determination may be made 150 as to whether the algorithm has completed a predefined number of iterations, has converged and/or has otherwise reached a completion condition. If so, an order in which to process the jobs and the path to be used for each job may be determined 155 from sequence probability matrix V and route probability matrix P. If not, the job and path selection process may be performed again using the updated sequence probability and route probability matrices.

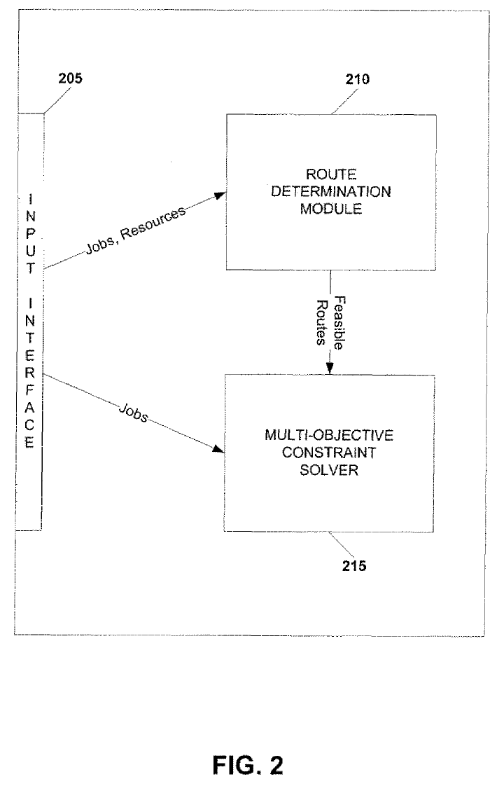

FIG. 2 depicts a block diagram for an exemplary system for performing multi-objective optimization according to an embodiment. As shown in FIG. 2, the system may include an input interface 205, a route determination module 210 and a multi-objective constraint solver 215.

The input interface 205 may receive information pertaining to a plurality of jobs and a plurality of objectives. For example, the information pertaining to each job may include, for example and without limitation, a description of one or more operations to be performed and/or one or more resources that may be utilized. Each objective may be based on at least one of a job, a feasible route for a job and a resource. A variable for each of the plurality of objectives may be evaluated and combined into a multi-objective function. In an embodiment, each variable may be weighted based on a relative importance of meeting the objective, as defined by a user. The plurality of objectives may include, without limitation, minimizing a total turnaround time for performing the plurality of jobs, minimizing a number of jobs that finish after a predefined time for each job, minimizing a total amount of time that each job finishes after the predefined time for the job, maximizing a utilization of the plurality of resources, and maximizing a total amount of time that each job finishes before the predefined time for the job. A feasible route may include an ordered sequence of one or more resources.

The route determination module 210 may determine a plurality of feasible routes for each job. Each feasible route may include one or more resources. Each resource may be assigned to perform at least one operation for the corresponding job. For example, a resource that can both fold paper and cut paper may be assigned to fold paper in a first feasible route, copy paper in a second feasible route, and fold and copy paper in a third feasible route. However, a resource may not be assigned for an operation that it is unable to perform.

The multi-objective constraint solver 215 may determine a sequence in which to perform the plurality of jobs and a feasible route for each job by determining substantially a best-case result for the multi-objective function for the plurality of jobs and the plurality of feasible routes. For example the best-case result may be a sequence of jobs and an assignment of resources that minimizes the value of the multi-objective function. In an alternate embodiment, the best-case result may be identified as the sequence of jobs and the assignment of resources that maximizes the multi-objective function.

In an embodiment, the multi-objective constraint solver 215 may be iteratively performed for one or more selection processes. Each selection process may select a job that has not previously been selected by the process in an iteration based on one or more first selection values. The first selection values may correspond to the sequence probability matrix V described above. Each selection process may also select a feasible route for the job based on one or more second selection values, such as the route probability matrix P described above. Such selections may be performed for each process until all jobs have been selected. The value for the multi-objective function may then be determined for each process based on the sequence in which the jobs were selected and the feasible route for each job. A process may be selected based on the value for its multi-objective function. One or more of the first selection values may be updated based on the sequence in which the jobs were selected by the selected process. In an embodiment, each first selection value may be multiplied by a value between about 0 and about 1. Each first selection value corresponding to the sequence in which the jobs were selected may additionally have an offset value added to it. In addition, one or more of the second selection values may be updated based on the selected feasible route for each job of the selected process.

In an embodiment, each second selection value may be multiplied by a value between about 0 and about 1. Each second selection value corresponding to the selected feasible route for each job may additionally have an offset value added to it.

The multi-objective constraint solver 215 may perform the above-described algorithm until a constraint is satisfied. In an embodiment, the constraint may include performing the algorithm a predefined number of times. In an embodiment, the constraint may include performing the algorithm until at least one first selection value and at least one second selection value surpasses a threshold. Alternate and/or additional constraints may be used within the scope of the present disclosure as will be apparent to those of ordinary skill in the art. In addition, a plurality of conditions and/or one of a plurality of conditions may be used to represent the constraint

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method for performing multi-objective optimization for scheduling a plurality of jobs, the method comprising
receiving a plurality of jobs, wherein each job requires the performance of one or more operations;
determining a plurality of feasible routes for each job, wherein each feasible route comprises one or more resources, wherein each resource is able to perform at least one operation for the job;
receiving a plurality of objectives, wherein the plurality of objectives are combined to form a multi-objective function, wherein each objective is based on at least one of a job, a feasible route and a resource; and
determining a sequence in which to perform the plurality of jobs and a feasible route for each job by determining a substantially best-case result for the multi-objective function for the plurality of jobs and the plurality of feasible routes.

2. The method of claim 1 wherein the plurality of objectives comprise one or more of the following:
minimizing a total turnaround time for performing the plurality of jobs;
minimizing a number of jobs that finish after a predefined time for each job;
minimizing a total amount of time that each job finishes after the predefined time for the job;
maximizing a utilization of the plurality of resources; and
maximizing a total amount of time that each job finishes before the predefined time for the job.

3. The method of claim 1 wherein the multi-objective function comprises weighted values for the plurality of objectives.

4. The method of claim 1 wherein each feasible route comprises an ordered sequence of one or more resources.

5. The method of claim 1 wherein determining a sequence and a feasible route comprises repeating the following steps until a condition is satisfied:
for each of one or more processes:
while at least one job has not been selected for the process:
selecting a job that has not previously been selected for the process based on one or more first selection values, and
selecting a feasible route for the job based on one or more second selection values, and
determining a value for the multi-objective function for the process based on the sequence in which the jobs were selected and the feasible route for each job;
selecting a process based on the value for its multi-objective function:
updating the one or more first selection values based on the sequence in which the jobs were selected by the selected process; and
updating the one or more second selection values based on the feasible route for each job for the selected process.

6. The method of claim 5 wherein the condition comprises a number of times to perform the steps.

7. The method of claim 5 wherein the condition comprises at least one of the one or more first selection values and the second selection values surpassing a threshold.

8. The method of claim 5 wherein selecting a process comprises selecting one or more of the process having a minimum value for its multi-objective function, the process having a maximum value for its multi-objective function, and the process having a median value for its multi-objective function.

9. The method of claim 5 wherein updating the one or more first selection values comprises:
multiplying each first selection value by a value between about 0 and about 1; and
for each first selection value corresponding to the sequence in which the jobs were selected, adding an offset value to the first selection value.

10. The method of claim 5 wherein updating the one or more second selection values comprises:
multiplying each second selection value by a value between about 0 and about 1; and
for each second selection value corresponding to the selected feasible route for each job, adding an offset value to the second selection value.

11. A system for performing multi-objective optimization for scheduling a plurality of jobs, the system comprising:
an input interface for receiving a plurality of jobs and a plurality of objectives, wherein each job requires the performance of one or more operations, wherein each objective is based on at least one of a job, a feasible route and a resource, wherein the plurality of objectives are combined to form a multi-objective function;
a route determination module for determining a plurality of feasible routes for each job, wherein each feasible route comprises one or more resources, wherein each resource is assigned to perform at least one operation for the job; and
a multi-objective constraint solver for determining a sequence in which to perform the plurality of jobs and a feasible route for each job by determining a substantially best-case result for the multi-objective function for the plurality of jobs and the plurality of feasible routes.

12. The system of claim 11 wherein the plurality of objectives comprise one or more of the following:
minimizing a total turnaround time for performing the plurality of jobs;
minimizing a number of jobs that finish after a predefined time for each job;
minimizing a total amount of time that each job finishes after the predefined time for the job;
maximizing a utilization of the plurality of resources; and
maximizing a total amount of time that each job finishes before the predefined time for the job.

13. The system of claim 11 wherein each feasible route comprises an ordered sequence of one or more resources.

14. The system of claim 11 wherein the multi-objective constraint solver iteratively performs the following steps until a condition is satisfied:
for each of one or more processes:
while at least one job has not been selected for the process:
selecting a job that has not previously been selected for the process based on one or more first selection values, and
selecting a feasible route for the job based on one or more second selection values, and
determining a value for the multi-objective function for the process based on the sequence in which the jobs were selected and the feasible route for each job;
selecting a process based on the value for its multi-objective function;
updating the one or more first selection values based on the sequence in which the jobs were selected by the selected process; and
updating the one or more second selection values based on the feasible route for each job for the selected process.

15. The system of claim 14 wherein the condition comprises a number of times to perform the steps.

16. The system of claim 14 wherein the condition comprises at least one of the one or more first selection values and the second selection values surpassing a threshold.

17. The system of claim 14 wherein updating the one or more first selection values comprises:
multiplying each first selection value by a value between about 0 and about 1; and
for each first selection value corresponding to the sequence in which the jobs were selected, adding an offset value to the first selection value.

18. The system of claim 14 wherein updating the one or more second selection values comprises:
multiplying each second selection value by a value between about 0 and about 1; and
for each second selection value corresponding to the selected feasible route for each job, adding an offset value to the second selection value.
